(19) United States
(12) Patent Application Publication
(10) Pub. No.: US 2019/0081371 A1
(43) Pub. Date: Mar. 14, 2019

(54) Heatable Battery

(71) Applicant: Bayerische Motoren Werke Aktiengesellschaft, Muenchen (DE)

(72) Inventors: Christoph BAUER, Muenchen (DE); Jan Philipp SCHMIDT, Muenchen (DE); Edwin KNOBBE, Pfaffenhofen an der llm (DE); Thomas HAMMERSCHMIDT, Unterschleissheim (DE)

(21) Appl. No.: 16/185,359

(22) Filed: Nov. 9, 2018

Related U.S. Application Data
(63) Continuation of application No. PCT/EP2017/060606, filed on May 4, 2017.

(30) Foreign Application Priority Data
May 11, 2016 (DE) 10 2016 208 062.8

(51) Int. Cl. H01M 10/615; H01M 10/625; H01M 10/6571

(52) U.S. Cl. CPC H01M 10/615; H01M 10/6571; H01M 10/625

(57) ABSTRACT

A heatable battery includes a battery cell with an anode and a cathode, an anode connection which is connected to the anode and a cathode connection which is connected to the cathode. A heating element is connected to one of the anode and cathode. The battery cell has a controllable switch which is arranged between the heating element and one of the anode and the cathode connection. The controllable switch is arranged in the interior of the battery cell.

### CROSS REFERENCE TO RELATED APPLICATIONS

This application is a continuation of PCT International Application No. PCT/EP2017/060606, filed May 4, 2017, which claims priority under 35 U.S.C. § 119 from German Patent Application No. 10 2016 208 062.8, filed May 11, 2016, the entire disclosures of which are herein expressly incorporated by reference.

### BACKGROUND AND SUMMARY OF THE INVENTION

The invention relates to a heatable battery, which can be used, for example, as a drive battery for electric vehicles.

A battery conventionally comprises a plurality of individual galvanic cells, the so-called battery cells. In order to construct a battery from the battery cells, the individual battery cells can be electrically connected in series.

Modern generations of drive batteries in vehicles, for example electric vehicles, exhibit temperature-dependent fluctuations in their power. Large power losses of the battery cells, which losses are caused by the internal resistance of the battery cells that is increased as a result of temperature, can often be identified, in particular at very low temperatures, for example temperatures lower than 0° C. This leads to a reduced power of the battery, which power is thus also available for the vehicle to only a reduced extent, and, indirectly, to a reduced amount of energy that can be drawn on account of overpotentials.

In order to ensure that the voltage generated by a battery cell is virtually independent of temperature fluctuations in the cell interior of the battery cell, the battery cell can be heated. For this purpose, a heating element has to be switched on when it is ascertained, for example, that the temperature of the battery cell falls below a specific predefined threshold value.

An objective of the present invention is to provide a heatable battery, which can be used to switch on a heating element with a low degree of circuitry complexity for the purpose of heating the battery in order to heat the cell interior of the battery.

An embodiment of a heatable battery according to the invention comprises a battery cell having an anode and a cathode, an anode terminal, which is connected to the anode, and a cathode terminal, which is connected to the cathode. A heating element is connected to one of the anode and cathode. The battery cell furthermore has a controllable switch, which is arranged between the heating element and one of the anode terminal and cathode terminal. The controllable switch is arranged in the interior of the battery cell.

In the specified heatable battery, the controllable switch is used to switch the heating operation of the battery on or off. The controllable switch can be designed as a MOSFET switch or as a relay for the purpose of current control. The controllable switch can be arranged in the cell interior of the battery in such a way that the controllable switch is surrounded by an electrolyte. According to a preferred embodiment, the controllable switch is embodied so as to be media-resistant, for example in hermetically encapsulated fashion.

Since the controllable switch is arranged in the interior of the battery cell of the heatable battery, an amount of heat that arises during operation of the electronic circuit of the controllable switch as losses is used to heat the cell. In contrast to an embodiment of the heatable battery in which the controllable switch is arranged on an outer surface of the cell housing of the battery cell, no additional component parts on the cell housing are required in the embodiment of the heatable battery according to the invention, in which the controllable switch is integrated directly in the interior of the cell housing. A housing bushing can be omitted with the advantage of less manufacturing outlay. Material can be saved on account of the cable paths that are shorter in comparison with a design, in which the controllable switch is arranged externally on the cell housing.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an embodiment of a heatable battery comprising a controllable switch on an outer surface of the cell housing of the battery.

FIG. 2 shows an embodiment of a heatable battery comprising a controllable switch, which is arranged in the interior of a battery cell of the heatable battery.

### DETAILED DESCRIPTION OF THE DRAWINGS

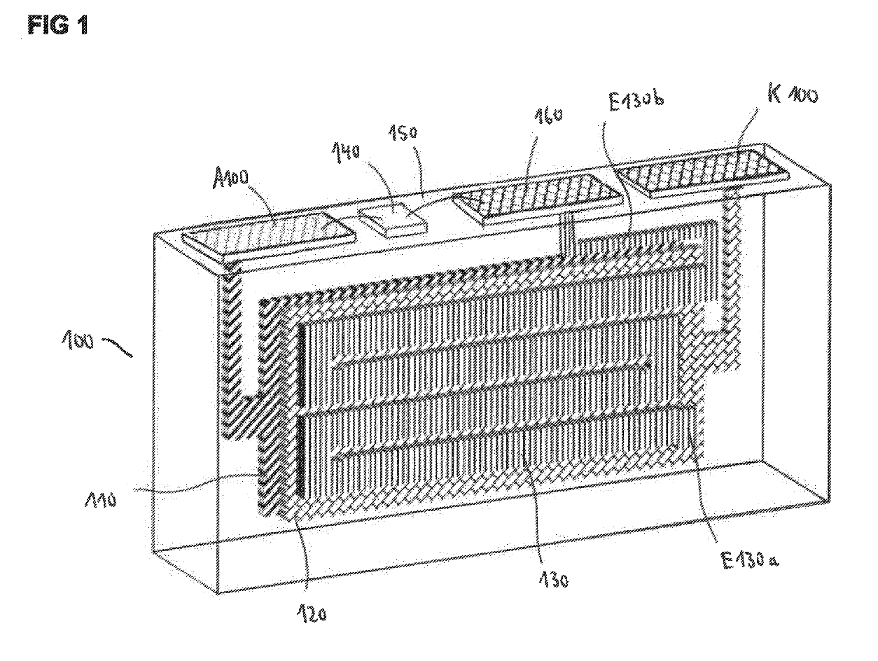

FIG. 1 shows an embodiment of a heatable battery 1 comprising a battery cell 100. The battery cell 100 has an anode 110 and a cathode 120. An anode terminal A100 is arranged on an outer surface of a cell housing 150 of the heatable battery, which anode terminal is connected to the anode 110. A cathode terminal K100 is furthermore arranged on the outer surface of the cell housing 150, which cathode terminal is connected to the cathode 120. The battery cell 100 of the heatable battery furthermore has a heating element 130. The heating element 130 can be arranged in the interior of the battery cell 100.

According to one embodiment, the heating element 130 can be designed as a conductive layer, which is arranged on the anode 110 or the cathode 120. The heating element 130 can be designed, for example, as a metallic conductor track or as a surface resistor, which is mounted on the anode 110 or the cathode 120. In the embodiment shown in FIG. 1, the heating element 130 in the configuration of a heatable layer is arranged on the cathode 120. The heatable layer can be, for example, a thin material web, which is arranged shaped in a meandering manner on the anode 110 or the cathode 120. A contact terminal 160 is arranged on the outer surface of the cell housing 150 for the purpose of contacting the heating element 130. An end E130a of the heating element 130 is connected to the cathode terminal K100, for example by way of the cathode 120. Another end E130b of the heating element 130 is connected to a contact terminal 160. The contact terminal 160 is arranged, like the anode terminal and the cathode terminal, on an outer surface of the cell housing 150.

A load can be connected between the anode terminal A100 and the cathode terminal K100. During operation of the heatable battery as intended, the battery cell 100 generates a voltage between the anode terminal A100 and the cathode terminal K100. The power provided by the battery cell is dependent on the temperature prevailing in the cell interior of the battery cell. Power losses can be expected, in particular, when a specific limit temperature is undershot. The voltage generated between the anode terminal and the cathode terminal then falls below a threshold value, with the result that the operation of a load that is fed by the battery is no longer guaranteed. In order to make it possible to operate the battery in the proper manner, the interior of the battery cell 100 can be heated by use of the heating element/the heatable layer 130.

To operate the heatable battery in heating operation, a controllable switch 140 is arranged on the outer surface of the cell housing 150 of the battery cell. The anode terminal A100 and the contact terminal 160 are connected to one another by way of the controllable switch 140. To heat the cell interior of the battery, a flow of current through the heating element/the heatable layer 130 has to be generated. To this end, the controllable switch 140 is switched to the on state. In the on state of the controllable switch 140, a circuit is closed between the anode 110/the anode terminal A100 and the contact terminal 160 and also the heating element 130 and the cathode terminal K100/the cathode 120, with the result that a heating current flows through the heating element/the heatable layer 130. The heating element/the heatable layer 130 heats up as a consequence of the flow of current and dissipates the heat generated in the process to the interior of the battery cell 100.

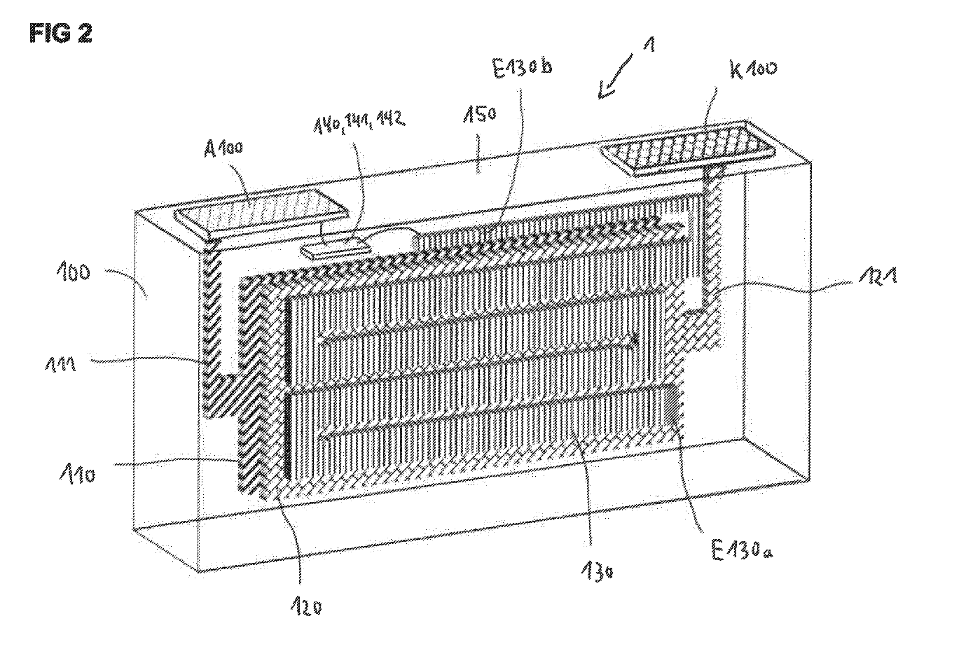

FIG. 2 shows a further embodiment of the heatable battery 1. Like in the embodiment shown in FIG. 1, the heatable battery comprises a battery cell 100 having an anode 110 arranged in the interior of the cell and a cathode 120. An anode terminal A100, which is connected to the anode 110, is arranged on the outer surface of a cell housing 150 of the battery cell. A cathode terminal K100, which is connected to the cathode 120 in the interior of the battery cell, is furthermore arranged on the outer surface of the cell housing 150.

The heating element 130 is provided to heat the cell interior. As explained in the exemplary embodiment of FIG. 1, the heating element 130 can be designed as a conductive layer, which is arranged on the anode 110 or the cathode 120. The heating element 130 can be designed, for example, as a metallic conductor track or as a surface resistor, which is mounted on the anode 110 or the cathode 120.

In the embodiment shown in FIG. 2, the heating element 130 in the configuration of a heatable layer is arranged on the cathode 120. The heating element 130 can be, for example, a thin metal film, which heats up when a current flows through the metal film. An end E130a of the heating element/the heatable layer 130 is connected to the electrode on which the heating element/the heatable layer 130 is arranged. In the embodiment shown in FIG. 2, the end E130a of the heating element/the heatable layer 130 is connected to the cathode and, by means of the feed line 121, to the cathode terminal K100. In one embodiment of the heatable battery, in which the heating element/the heatable layer 130 is arranged on the anode 110, the end E130a of the heating element/the heatable layer 130 is connected to the anode 110 and, by means of the feed line 111, to the anode terminal A100.

Like in the exemplary embodiment of FIG. 1, the heatable battery 1 has a controllable switch 140. A flow of current through the heating element/the heatable layer 130 can be generated or disconnected by way of the controllable switch 140. In contrast to the embodiment shown in FIG. 1, the controllable switch 140 is arranged in the interior of the battery cell 100. The controllable switch 140 is connected, in particular, to an end E130b of the heating element/the heatable layer 130 in the cell interior. The controllable switch 140 is furthermore connected to the anode terminal A100. In one embodiment, in which the heating element/the heatable layer 130 is arranged on the anode 110, the controllable switch 140 is connected between the end E130b of the heating element/the heatable layer 130 and the cathode terminal K100.

During operation as intended, in which the battery cell 100 generates a voltage between the anode terminal A100 and the cathode terminal K100, a load is arranged between the anode terminal A100 and the cathode terminal K100. As mentioned above, the power of the battery or the voltage provided by the battery cell is usually dependent on a temperature in the interior of the battery cell. In particular, when a specific limit temperature in the interior of the battery cell has been undershot, the performance of the battery cell decreases, with the result that the voltage generated by the battery cell between the anode terminal A100 and the cathode terminal K100 can drop below a threshold value.

In order to guarantee operation of the battery cell as intended, the interior of the battery cell is heated when a threshold value of the cell temperature is undershot. To this end, the heatable battery is operated in heating operation. To activate the heating operation, the controllable switch 140 is switched to the on state. As a result thereof, a current flows from the anode 110/the anode terminal A100 to the controllable switch 140, which has been turned on, and through the heating element/the heatable layer 130 to the cathode 120. As a consequence of the flow of current, the heating element/the heatable layer 130 is heated. The heat generated in the process can be dissipated to the interior of the battery cell, with the result that the operating temperature of the battery increases again.

In contrast to the embodiment illustrated in FIG. 1, in the embodiment illustrated in FIG. 2, the controllable switch 140 is arranged in the interior of the battery cell 100. In the embodiment illustrated in FIG. 2, in which the heating element/the heatable layer 130 is arranged on the cathode, the controllable switch 140 is arranged between the anode terminal A100 and the end E130b of the heatable layer 130. In an alternative embodiment, in which the heating element/the heatable layer 130 is arranged on the anode 110, the controllable switch 140 is arranged between the cathode terminal K100 and the end E130b of the heating element/the heatable layer 130.

The controllable switch 140 can be designed as a MOSFET switch 141 or as a relay 142 for the purpose of current control.

According to an advantageous embodiment, the controllable switch 140 in the interior of the battery cell is coated so as to be media-resistant. This ensures that the controllable switch 140 is not damaged by the acid constituents of the electrolyte of the battery.

To activate the heating operation, the controllable switch 140 is switched to the on state. To this end, either a communication line (not illustrated in FIG. 2) can run from the outside into the interior of the battery cell 100 to the controllable switch 140. For example, a control signal can be transmitted via such a communication line, which control signal switches the controllable switch to the on or off state. The heating operation is deactivated in the off state of the controllable switch.

According to a further embodiment, the communication with the controllable switch, in particular the turning of the controllable switch on or off, can be carried out by way of power line communication. In this configuration, to control the controllable switch, the control signal is applied, for example, to the anode terminal A100 or to the cathode terminal K100.

The embodiment of the heatable battery illustrated in FIG. 2 has the advantage that, in comparison to the embodiment shown in FIG. 1, no additional component parts are arranged on the cell housing 150. In particular, the contact terminal 160 or the arrangement of the controllable switch 140 itself on the cell housing 150 can be omitted. In comparison with the embodiment shown in FIG. 1, material can be saved on account of the shorter cable paths. Furthermore, the heatable battery can be produced with a significantly lower level of manufacturing outlay since a housing bushing of a conductor track from the heating element/the heatable layer 130 to the contact terminal 160 can be omitted.

A further advantage consists in the fact that the heat losses that arise during operation of the controllable switch 140 are dissipated immediately into the cell interior, which proves advantageous for the rapid heating of the cell interior of the battery cell. In comparison therewith, in the embodiment shown in FIG. 1, the heat that arises as losses in the externally arranged controllable switch is not used to heat the cell of the battery.

### LIST OF REFERENCE DESIGNATIONS

100 Battery cell
110 Anode
120 Cathode
130 Heating element/heatable layer
140 Controllable switch
150 Cell housing
160 Contact terminal

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A heatable battery, comprising:
a battery cell,
wherein the battery cell has an anode and a cathode, an anode terminal, which is connected to the anode, and a cathode terminal, which is connected to the cathode, and a heating element, which is connected to one of the anode and cathode,
wherein the battery cell has a controllable switch, which is arranged between the heating element and one of the anode terminal and cathode terminal, and
wherein the controllable switch is arranged in an interior of the battery cell.

2. The heatable battery as claimed in claim 1, wherein
the heating element is designed as a heatable layer, which is arranged on the anode, and
the controllable switch is arranged between the cathode terminal and the heatable layer.

3. The heatable battery as claimed in claim 1, wherein
the heating element is designed as a heatable layer, which is arranged on the cathode, and
the controllable switch is arranged between the anode terminal and the heatable layer.

4. The heatable battery as claimed in claim 1, wherein
the controllable switch is a MOSFET switch or a relay for purpose of current control.

5. The heatable battery as claimed in claim 1, wherein
the battery cell is heated in an on state of the controllable switch.

6. The heatable battery as claimed in claim 1, wherein
the heating element is designed as a surface resistor, which is arranged on a surface of the anode or the cathode.

7. The heatable battery as claimed in claim 6, wherein
the heating element is a conductor track, which is arranged on the surface of the anode or the cathode.

8. The heatable battery as claimed in claim 1, wherein
the anode terminal and the cathode terminal are arranged on an outer surface of the housing of the battery cell.

9. The heatable battery as claimed in claim 1, wherein
the controllable switch is coated to be media-resistant.

10. The heatable battery as claimed in claim 1, wherein
the controllable switch is switched to the on or off state via a control signal, which control signal is applied to the anode terminal or cathode terminal or which is transmitted to the controllable switch via a communication line from the outside into the interior of the battery cell.
